(19) United States
(12) Patent Application Publication
(10) Pub. No.: US 2026/0067772 A1
(43) Pub. Date: Mar. 5, 2026

(54) ENERGY OPTIMIZED CELL RESELECTION MEASUREMENT

(71) Applicant: GOOGLE LLC, Mountain View, CA (US)

(72) Inventor: Jose Andres Cesares Cano, Nuremberg (DE)

(21) Appl. No.: 18/955,097

(22) Filed: Nov. 21, 2024

Related U.S. Application Data
(60) Provisional application No. 63/688,722, filed on Aug. 29, 2024.

(51) Int. Cl. H04W 36/00; H04B 17/318; H04W 76/28

(52) U.S. Cl. CPC H04W 36/0088; H04B 17/328; H04W 76/28

(57) ABSTRACT

A user equipment is configured for wireless communication with a serving cell. The user equipment includes a wireless interface configured for wireless communication with the serving cell and a modem coupled to the wireless interface. The modem implements a state machine configured to selectively operate in one of three states. In the first state, the user equipment bypasses scheduling of cell reselection measurements of inter-frequency layers. In the second state, the user equipment schedules cell reselection measurements of subsets of the inter-frequency layers in different time intervals. In the third state, the user equipment schedules cell reselection measurements of the inter-frequency layers in response to a measured signal strength parameter associated with the serving cell of the user equipment being below a threshold value.

### BACKGROUND

The Third Generation Partnership Project (3GPP) defines standards and protocols that govern, among other things, the handover of user equipment between different cells that provide wireless connectivity to the user equipment over an air interface. Examples of the standards defined by the 3GPP include the Fourth Generation Long Term Evolution (4G LTE) and Fifth Generation New Radio (5G NR) standards. User equipment that operates according to these standards can maintain connections with a serving cell in a connected mode or an idle mode. The connected mode is an active state where the user equipment can communicate directly with the network for data transfer and signaling. This state supports application data exchange and network control tasks such as handovers. The idle mode is a low-activity state designed to conserve battery life and manage user equipment mobility without active communication. In this state, the user equipment is not actively engaged in data transfer but can still receive system information and paging messages. To conserve battery power, an idle user equipment typically spends most of its time in sleep mode and awakes at predetermined intervals to monitor the air interface for messages transmitted by the serving cell. This mode of operation is referred to as discontinuous reception (DRX).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a communication system that supports energy-optimized cell reselection measurements, according to some embodiments.

FIG. 2 illustrates a method of determining the measurement rules used to determine whether to perform cell reselection measurements, according to some embodiments.

FIG. 3 illustrates a state machine that governs how a user equipment performs cell reselection measurements, according to some embodiments.

### DETAILED DESCRIPTION

An idle user equipment performs cell reselection procedures based upon configuration information provided by the network in system information blocks (SIBs) transmitted to the user equipment by its serving cell. For example, the idle user equipment can be configured to monitor inter-frequency layers to detect signals transmitted by other cells on different frequencies and measure the signal strengths of the detected signals. The configuration information includes a threshold value of the strength of a signal received from the current serving cell. For example, the threshold value can be represented as a reference signal received power (RSRP) or a reference signal received quality (RSRQ). The idle user equipment is configured to monitor the inter-frequency layers if the measured signal strength parameter falls below the threshold value. The user equipment can hand off from its current serving cell to a new serving cell based on the measured signal strengths according to procedures defined by the protocol implemented in the network.

The configuration parameters provided by the network can force the idle user equipment to perform unnecessary searches and monitoring of the inter frequency layers. For example, the RSRP threshold (SnonIntraSearch) defined by some service providers is 62 dB, and the idle user equipment is required to search and measure all inter-frequency layers if the measured RSRP of its current serving cell (Srxlev) is less than 62 decibels (dB). The idle user equipment can also be required to search all high-priority frequency layers regardless of the measured RSRP of its current serving cell. In actual deployments, the signal strength received by the idle user equipment from its serving cell is almost always sufficiently low to satisfy the criterion that triggers searching and measuring all inter-frequency layers, even under excellent serving cell conditions and relatively high RSRP and RSRQ. The idle user equipment is therefore forced to make unnecessary searches and measurements of the inter-frequency layers, which has a substantial impact on user experience because the unnecessary searches and measurements consume power and reduce battery lifetime.

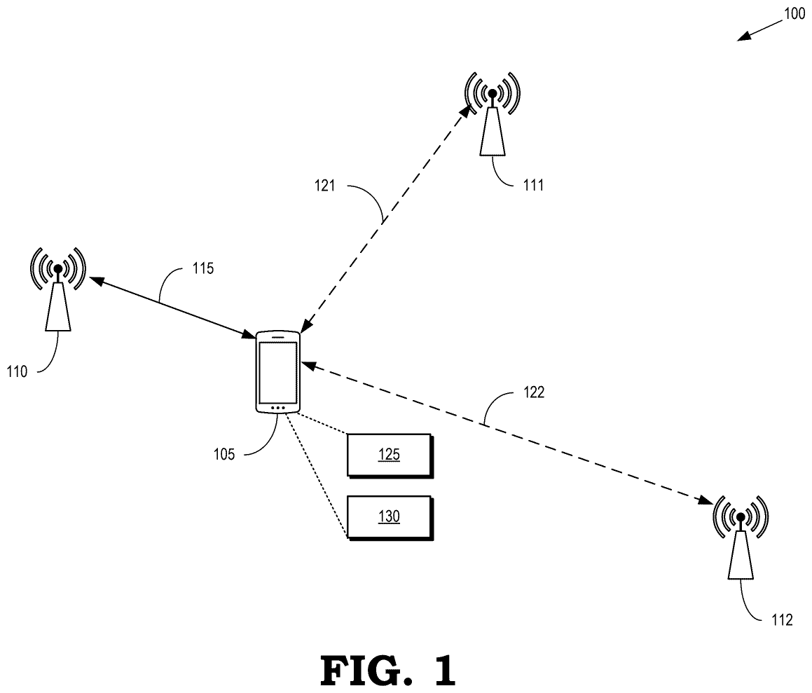

FIGS. 1-3 illustrate user equipment that implements a state machine to selectively operate in one of three states. In the first state, the user equipment bypasses scheduling of cell reselection measurements of inter-frequency layers. In the second state, the user equipment schedules cell reselection measurements of subsets of the inter-frequency layers in different time intervals. In the third state, the user equipment schedules cell reselection measurements of the inter-frequency layers in response to a measured signal strength parameter associated with a serving cell of the user equipment being below a threshold value.

State transitions in the state machine are determined based on a set of parameters. In some embodiments, a first parameter indicates service quality provided by a serving cell of the user equipment and a second parameter that indicates a threshold signal strength provided to the user equipment by the serving cell. The first parameter can be determined based on a comparison of an error rate for paging messages to a threshold value, such as 5%, and the second parameter can be determined based on a typical RSRP that triggers inter-frequency layer measurements, such as an RSRP of −116 dBm. The second parameter can also be determined using a filtered version of the serving cell RSRP that has a lower level of fluctuations between DRX cycles. In the second state, measurements of the inter-frequency layers are scheduled at predetermined time intervals so that subsets of the measurements are performed in successive time intervals. In some embodiments, cell reselection measurements are performed in successive 60-second time intervals and one (or a subset) of the frequency layers is evaluated in each 60-second time interval.

FIG. 1 illustrates a communication system 100 that supports energy-optimized cell reselection measurements, according to some embodiments. The communication system 100 includes one or more user equipment 105 that can establish wireless connections over an air interface with one or more base stations or cells 110, 111, 112, which are collectively referred to hereinafter as “the cells 110-112.” The user equipment 105 and the cells 110-112 operate according to standards and protocols such as the standards defined by the 3GPP. For example, the user equipment 105 and the cells 110 can operate according to the Fourth Generation Long Term Evolution (4G LTE) standard or the Fifth Generation New Radio (5G NR) standard. In the illustrated embodiment, the user equipment 105 has established a connection 115 with the cell 110, which is therefore referred to as the current serving cell of the user equipment 105. To facilitate this operation, the user equipment 105 includes one or more wireless interfaces 125 (e.g., one or more arrays of radio frequency antennas and supporting components) and at least one modem 130 to interface with the one or more wireless interfaces 125.

The user equipment 105 can maintain the connection 115 with the serving cell 110 while the user equipment 105 is in an idle state. In some embodiments, the user equipment 105 operates in a DRX mode so that the idle user equipment 105 is only required to wake up and monitor the connection 115 during predetermined time intervals. The serving cell 110 maintains the connection 115 in the DRX mode and so the serving cell 110 does not attempt to transmit information to the user equipment 105 outside of the predetermined time intervals. During the predetermined time intervals, the serving cell 110 transmits messages, such as paging messages, to the serving cell 110 via the connection 115.

The serving cell 110 transmits system information blocks (SIBs) containing configuration information to the user equipment 105. The configuration information is used to configure the user equipment 105 to perform cell reselection procedures such as monitoring inter-frequency layers to detect signals transmitted by other cells on different frequencies. The configuration information includes a threshold value of the strength of a signal received from the current serving cell such as a reference signal received power (RSRP) or a reference signal received quality (RSRQ). The threshold value is used to determine whether to perform cell reselection measurements. If a signal is detected, the user equipment 105 measures the signal strengths of the detected signal(s). In the illustrated embodiment, the user equipment 105 is configured to search and monitor signals received over the air interface by the cells 111, 112, as indicated by the dashed arrows 121, 122. However, as discussed herein, determining whether to perform cell reselection measurements only based on the threshold values provided by the serving cell 110 can cause the user equipment 105 to perform unnecessary cell reselection measurements, which can drain the battery in the user equipment 105.

The user equipment 105 therefore utilizes the modem 130 to maintain a state machine (not shown in FIG. 1 in the interest of clarity) that allows the user equipment 105 to selectively operate in one of three states. In the first state of the state machine, the user equipment 105 bypasses scheduling of cell reselection measurements of inter-frequency layers. In the second state, the user equipment 105 schedules cell reselection measurements of subsets of the inter-frequency layers in different time intervals. In the third state, the user equipment 105 schedules cell reselection measurements of the inter-frequency layers in response to a measured signal strength parameter associated with the serving cell 110 of the user equipment 105 being below a threshold value. The state machine transitions between the three states based on a first parameter that indicates service quality provided by the serving cell 110 and a second parameter that indicates a threshold signal strength provided to the user equipment 105 by the serving cell 110. Transitions in the state machine can also be constrained by a hysteresis.

The user equipment 105 can evaluate the connection 115 to the serving cell 110, as well as determining a quality of signals received over the connection 115 over the interface, a strength of the signals received over the connection 115, and the like. Based on this evaluation, the user equipment 105 operates in one of a plurality of states that use different sets of rules to govern radio resource management (RRM) mobility of the user equipment 105. Some embodiments of the modem 130 of the user equipment 105 are configured with a set of parameters that are used to determine whether to use the conventional rules for performing cell reselection measurements or whether to use the state machine to determine whether to perform cell reselection measurements. In some embodiments, the set of parameters includes:
PAGING_THRESHOLD: a parameter indicating a paging block error rate (BLER) threshold. The PAGING_THRESHOLD can be set to an initial value of 5%.
HIGH_SNONINTRASEARCH: a parameter that indicates a high value of a network configuration parameter (SnonIntraSearch) that is used to determine whether to perform cell reselection measurements. An initial value of HIGH_SNONINTRASEARCH can be 40 dB.
TYP_RSRP_THRESHOLD: a parameter that indicates a typical RSRP threshold that triggers inter-frequency layer measurements. An initial value of TYP_RSRP_THRESHOLD can be −116 dBm.

The user equipment 105 can determine the value of a parameter that indicates an evaluation of the quality of signals received from the serving cell 110. This parameter can be referred to as a serving cell quality evaluation (SQE) and the SQE is set to FALSE by default. In some embodiments, the user equipment 105 determines a BLER for paging messages received by the user equipment 105. The measured value of the paging BLER is then compared to a configured threshold value, PAGING_THRESHOLD, and the value of the SQE is updated based on the comparison. For example, if the paging BLER<PAGING_THRESHOLD, then the SQE is set to TRUE. However, in other embodiments, the user equipment 105 employs other techniques to evaluate the quality of signals received from the serving cell 110 such as reading a master information block (MIB) transmitted by the serving cell or tracking/fine-tuning cell timing. Some embodiments of the user equipment 105 measure the RSRP for signals received from the serving cell 110 and then filter the signals to generate a filtered RSRP, which is referred to as the RSRPsc. The RRPsc is expected to have low fluctuations between DRX cycles in relatively stable wireless channel conditions.

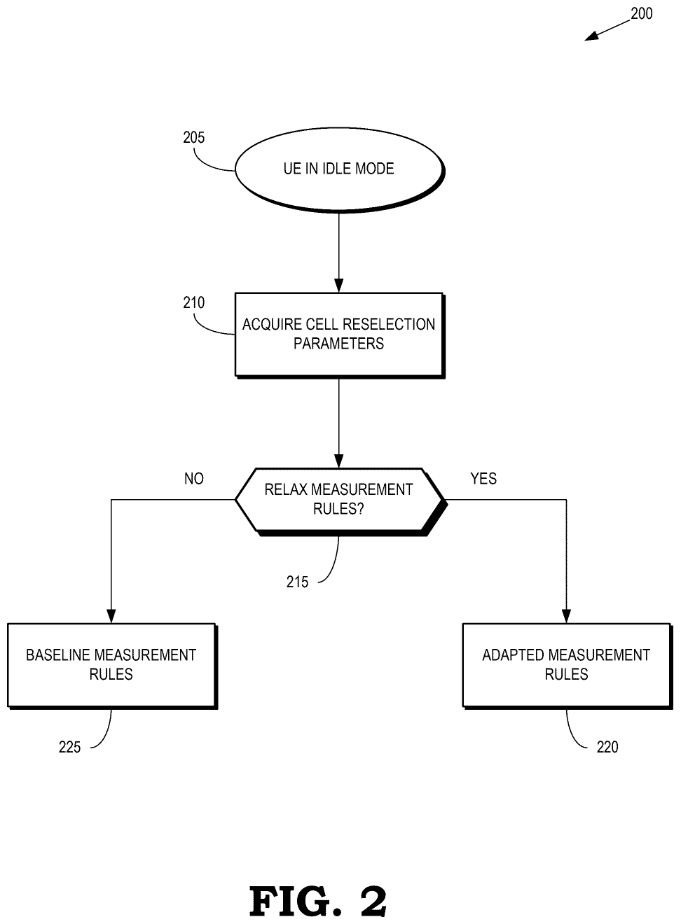

FIG. 2 illustrates a method 200 of determining the measurement rules that are used to determine whether to perform cell reselection measurements, according to some embodiments. The method 200 is implemented in user equipment such as some embodiments of the user equipment 105 shown in FIG. 1.

In an initial state (block 205), the user equipment is in an idle mode.

At block 210, the user equipment acquires cell reselection parameters from its serving cell. In some embodiments, the user equipment acquires the cell reselection parameters in SIBs that are broadcast by the serving cell. One of the acquired cell reselection parameters (SnonIntraSearch) is used to determine whether to perform cell reselection measurements, as discussed herein.

At block 215, the user equipment determines whether to use conventional measurement rules or use the state machine to determine whether to perform cell reselection measurements. As discussed herein, the conventional measurement rules determined by the network configuration parameters can be suboptimal and lead to unnecessarily high levels of power consumption. The user equipment can reduce overall power consumption by switching to the state machine to relax the measurement rules that determine radio resource management (RRM) mobility actions for the user equipment. In some embodiments, the user equipment compares the acquired cell reselection parameters to the configured thresholds to select between conventional, baseline rules or the state machine. For example, the user equipment can determine whether SnonIntraSearch>HIGH_SNONINTRASEARCH. If the user equipment chooses to use the state machine to relax the RRM measurement rules, the method 200 flows to the block 220. Otherwise, the method 200 flows to the block 225.

At block 220, the user equipment uses the state machine to determine whether to perform cell reselection measurements.

At block 225, the user equipment uses conventional measurement rules to determine whether to perform cell reselection measurements. In some embodiments, conventional or baseline measurement rules require that the user equipment performs cell reselection measurements if the measured RSRP of its current serving cell is less than the configured threshold. For example, the RSRP threshold (SnonIntraSearch) defined by some service providers is 62 dB, and the conventional measurement rules require that the idle user equipment search and measure all inter-frequency layers if the measured RSRP of its current serving cell (Srxlev) is less than 62 dB. The conventional or baseline measurement rules can also require cell reselection measurements be performed on high-priority frequency layers regardless of the received signal strength.

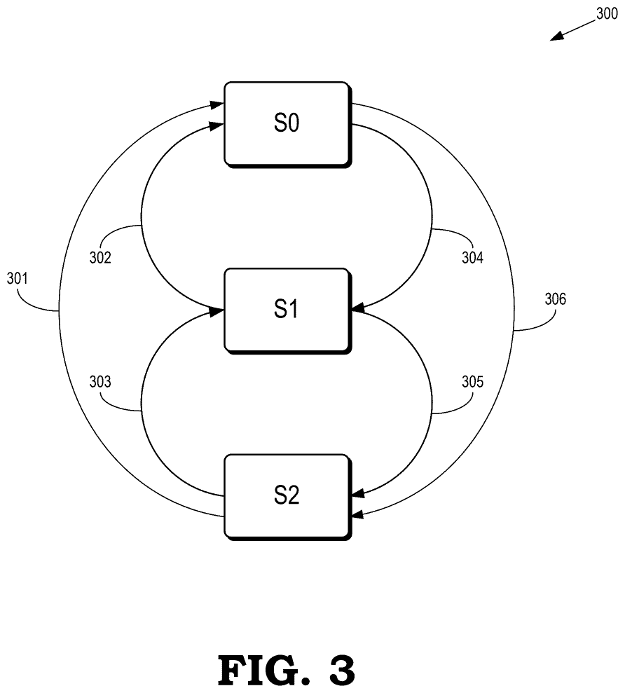

FIG. 3 illustrates a state machine 300 that governs how user equipment perform cell reselection measurements, according to some embodiments. The state machine 300 is implemented in some embodiments of the user equipment 105 shown in FIG. 1 and block 220 of the method 200 shown in FIG. 2.

The state machine 300 includes three states: S0, S1, and S2 and transitions between the states are governed by based on a first parameter that indicates service quality provided by the serving cell (e.g., the value of SQE) and a second parameter that indicates a threshold signal strength provided to the user equipment by the serving cell (e.g., the configured value of TYP_RSRP_THRESHOLD). As discussed herein, the value of SQE is either TRUE or FALSE. The state machine 300 evaluates the parameters indicating the serving cell quality and the received signal strength or quality at predetermined intervals. In some embodiments, the state machine 300 evaluates the parameters during every DRX cycle.

Transitions between the three states: S0, S1, and S2 are performed by comparing the parameter values to configured values are thresholds. The possible transitions for entering and leaving are indicated by the arrows 301, 302, 303, 304, 305, 306, which are collectively referred to herein as “the transitions 301-306.”

The state machine 300 remains in (or transitions to) the state S0 if the value of SQE is TRUE and RSRPsc>TYP_RSRP_THRESHOLD. For example, the state machine 300 can make the transitions 301 or 302 if this criterion is satisfied. The user equipment bypasses scheduling cell reselection measurements on inter-frequency layers when the state machine 300 is in the state S0. Thus, battery power or lifetime are increased because energy is not expended on performing the cell reselection measurements.

The state machine 300 remains in (or transitions to) the state S1 if the value of SQE is TRUE and RSRPsc<=TYP_RSRP_THRESHOLD. For example, the state machine 300 can make the transitions 303 or 304 if this criterion is satisfied. The user equipment enters a “relaxed” scheduling mode for cell reselection measurements when the state machine 300 is in the state S1. In the relaxed scheduling mode, the user equipment schedules cell reselection measurements of subsets of the inter-frequency layers at predetermined time intervals. In some embodiments, the user equipment schedules the cell reselection measurements of the subsets of the inter-frequency layers in successive time intervals. For example, the user equipment can schedule cell reselection measurements on the inter-frequency layers as follows:
Each frequency layer is searched every K×60 seconds, where K is the number of inter-frequency layers. The scheduling algorithm can implement a Round Robin approach or other scheduling techniques.
Measurements for a frequency-layer are started upon completion of the associated search and executed in consecutive DRX cycles until the Cell Reselection Evaluation is completed on that frequency layer.

The state machine 300 remains in (or transitions to) the state S2 if the value of SQE is FALSE. For example, the state machine 300 can make the transitions 305 or 306 if this criterion is satisfied. The user equipment schedules the cell reselection measurements according to baseline measurement rules, e.g., as implemented in block 225 of FIG. 2.

In some embodiments, a hysteresis is applied to the transitions 311-316. For example, the state S2 can be considered the default state because the state S2 is the safest in terms of performance, although this comes at the expense of energy consumption in the state S2 being the least efficient of the three states S0, S1, and S2. The hysteresis also constrains the state machine 300 to enter or leave during predetermined DRX cycles. For example, the hysteresis can define:
(S0_ENTRY, S0_LEAVE) DRX cycles. In some cases, the initial values can be (10, 1) DRX cycles.
(S1_entry, S1_leave) DRX cycles. In some cases, the initial values can be (5, 2) DRX cycles.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is as set forth in the claims below.

What is claimed is:

1. A user equipment configured for wireless communication with a serving cell, the user equipment comprising:
a wireless interface configured for wireless communication with the serving cell; and
a modem coupled to the wireless interface, the modem implementing a state machine configured to selectively operate in a first state that bypasses scheduling of cell reselection measurements of inter-frequency layers, a second state that schedules cell reselection measurements of subsets of the inter-frequency layers in different time intervals, or a third state that schedules cell reselection measurements of the inter-frequency layers in response to a measured signal strength parameter associated with the serving cell of the user equipment being below a threshold value.

2. The user equipment of claim 1, wherein the state machine is configured to transition between the first state, the second state, and the third state based on a first parameter that indicates service quality provided by the serving cell and a second parameter that indicates a threshold signal strength provided to the user equipment by the serving cell.

3. The user equipment of claim 2, wherein the first parameter is determined based on a comparison of an error rate for paging messages to a threshold value of the error rate, and wherein the second parameter is determined based on a reference signal received power (RSRP) that triggers inter-frequency layer measurements.

4. The user equipment of claim 3, wherein the threshold value of the error rate is 5%, and wherein the RSRP that triggers inter-frequency layer measurements is −116 dBm.

5. The user equipment of claim 1, wherein the user equipment schedules cell reselection measurements of subsets of the inter-frequency layers at predetermined time intervals in the second state.

6. The user equipment of claim 5, wherein the user equipment schedules the cell reselection measurements of the subsets of the inter-frequency layers in successive time intervals.

7. The user equipment of claim 6, wherein the user equipment schedules the cell reselection measurements are performed in successive 60-second time intervals and cell reselection measurements for one of the inter-frequency layers are scheduled in each 60-second time interval.

8. The user equipment of claim 1, wherein the state machine transitions between the first state, the second state, and the third state based on a hysteresis generated based on cycles of discontinuous transmission (DRX) between the user equipment and the serving cell.

9. A method, comprising:
configuring a user equipment based on parameters received from a network; and
selectively operating, based on the parameters, the user equipment in one of a first state that bypasses scheduling of cell reselection measurements of inter-frequency layers, a second state that schedules cell reselection measurements of subsets of the inter-frequency layers in different time intervals, or a third state that schedules cell reselection measurements of the inter-frequency layers in response to a measured signal strength parameter associated with the serving cell of the user equipment being below a threshold value.
